(19) United States
(12) Patent Application Publication
(10) Pub. No.: US 2007/0265824 A1
(43) Pub. Date: Nov. 15, 2007

(54) Diversified semantic mapping engine (DSME)

(76) Inventor: Michel David Paradis, Allentown, PA (US)

Correspondence Address: lawApe, LLC;The Law Office of Eastburn & Gray, 60 East Court Street, Doylestown, PA, 18901-0137, US

(21) Appl. No.: 11/800,077

(22) Filed: May 4, 2007

Related U.S. Application Data
(60) Provisional application No. 60/800,309, filed on May 15, 2006.

(51) Int. Cl. G06F 17/20

(52) U.S. Cl. 704/1

(57) ABSTRACT

The Diversified Semantic Mapping Engine (DSME) exploits user-defined word and document class designations to differentially formalize the semantic content of a language source. The coordination of these classes, especially when based upon naturally occurring classes in the language, such as part-of-speech, provides a rich, machine readable and automatically generated semantic map of the language source for use in diverse applications.

### BACKGROUND

Natural Language Processing has become central to information applications, market research, customer service and academic research, to name a few fields. One of the principle difficulties facing NLP, however, is the ability to produce structured, machine readable data about the language that is significant and structured. The “meaning” of language has been historically a philosophical question rather than a computational one, but the need for automatically generated semantic choices demands computational answers.

The simplest way in which semantic data has been represented historically is through lexicons. Lexicons, such as dictionaries and thesauri, can be either human or machine readable and provide hand-constructed indices of the language. The WordNet project is probably the largest and most significant attempt to construct a systematic representation of the English language that is machine readable and organized according to principals from which semantic choices can be generalized. WordNet, however, and the many other ontologies similar in design and application, are constructed principally by hand, through supervised algorithms and classical lexicography.

The problem these present is that they are necessarily limited in scope by the imagination and perseverance of those who constructed them. They also risk long term rigidity in the face of natural language change. Ultimately, they provide hand constructed maps of the language that are of use only insofar as their intended or consequential semantic representations are of use to a specific task.

The effort to depict naturally occurring language in such a structured way has been considerably difficult in returning results and has been pursued largely in the subfield of corpus linguistics. The principal means by which semantic information has been extracted from corpora have relied upon heuristic approaches that look for regularly occurring lexico-syntactic constructs from which to estimate semantic characteristics. One such method, for example, could employ the phrase “the X of the Y,” where X and Y are variables for words or phrases. A system could then troll through a corpus for occurrences of this phrase and return any word X as a likely component of the word Y, since the “of the” phrase is usually deployed to convey metonomy between X and Y. Turney & Littman have done this with the most sophistication by using tensors to represent multitudes of these lexico-syntactic constructs. Their results were some of the best to date in replicating the responses to analogy questions.

While these methods have come closer to representing language as it is used, they risk some of the same problems of rigidity faced by the directly lexicographical methods. They are often only able to capture measurements for frequently occurring words and are largely incapable of representing novel, infrequent or idiosyncratic uses of words or recognizing lexical relationships where meaning is a matter of degree.

The most knowledge-poor method previously attempted for generating a graph of English underlies the core technology upon which the DSME is based. In the early 1990s, computers were used for the first time to decompose word sequences, typically with the use of tensors, into numerical representations of word meaning. This method, called “clustering,” “vector-space” and “word-space” in the literature, distributes co-occurring words typically into vectors, where each dimension represents another word found in the corpus. These vectors summarize word usage by treating as elements the statistical regularity with which individual words co-occur.

These efforts were largely directed at automatic thesaurus generation, premised on the replacability hypotheses. This hypothesis held that words used in a similar way would be similar in meaning. The efforts were largely unsuccessful, however, as these methods were often poor at distinguishability, that is discriminating between truly similar words and words that merely bore some obvious relationship to one another, such as antonyms or meronyms. In his book on statistical linguistic analysis, Charniak cites the phenomenon in a section called “Problems with Word Clustering” and points to it as ‘some possibly intrinsic limits to how finely we can group semantically simply by looking at surface phenomena’. (Charniak 1993: 145).

The DSME proceeds from this basic method, using tensors to decompose and represent word usage, but solves the distinguishability problem by automatically dividing the tensor dimensions into user defined word classes. These word classes provide, often derived from empirically observable natural language phenomenon, such as part of speech, provide a robust way to generalize word meaning computationally and generate structural depictions of a naturally occurring language source with the semantic richness of an ontology.

### BRIEF SUMMARY OF THE INVENTION

The DSME provides a solution to the problem of representing semantic content computationally. It does so by constructing a numerical map of a language source, that is by automatically generating a rich semantic ontology. The method numerically generalizes the language source by decomposing its lexical sequence into lexical classes. These lexical classes are user defined for the purpose of measuring some syntactic or semantic aspect of the language source. The DSME treats these lexical classes as unique dimensions of a semantic space and yields a semantic map of the language source. These maps can then be graphically represented for the purpose of human language analysis or numerically for the purpose of computational application.

### BRIEF DESCRIPTION OF THE SEVERAL VIEWS OF THE DRAWINGS

Not applicable

### DETAILED DESCRIPTION OF THE INVENTION

1. The DSME, or “wordprism” as it was called in Provisional Patent 60/800,309, generates maps of lexical sources by coordinating their usage within arbitrary, user-defined classes. The underlying computational methodology is well-known in the computational linguistics community, variously called “clustering,” “vector-space” or “wordspace.” It cross-correlates the words of a language source as the unique dimensions of a tensor, the elements of which are derived statistically from the word's usage in the language source. The method was pioneered through document retrieval applications, where word by document matricies were used to return documents relevant to a search query. The method was expanded in a series of studies through the use of word by word similarity matricies, but failed to develop because the results were often muddled and difficult to characterize.

2. The DSME is most simply implemented by elaborating this basic method computationally through the use of a rank-three tensor X^{ijk}. The dimensions of X^{ij} correspond to the words found within a given language source. This forms a square similarity matrix, where the dimensions correspond to documents, words, phrases, etc. The dimensions of X^{k} correspond to the user-defined semantic classes into which the language source has been divided by the user, such as part of speech, negated words, quotes, citations, etc.

3. The elements of X^{ijk} are derived by the statistical analysis of corpora to derive the rates at which words co-occur. Thus, for example, if X^{ijl} represents a noun dimension, the values represented therein will correspond to the statistical significance of the words within X^{ij} occurring with the nouns in X^{ij}. The result is a complex semantic map of the data source where the k-dimensions are cross-correlated with the i/j-dimensions. Thus, one can employ some tensor function, such as cosine, to compare the commonality of two tensors (X₁^{ijk} and X₂^{ijk}), derived by linear combination of some or all the k-dimensions of X₁^{ijk} and X₂^{ijk} to ascertain the semantic proximity of the contents of X₁^{ijk} and X₂^{ijk} with respect to a user identified semantic relationship.

4. DSME maps have been experimentally shown to accurately correspond with human intuitions of various semantic relationships. When X^{ijk} represents a single language source, such as a document, the tensor functions reveal the semantic structure of that language source. When X^{ijk} represents a collected universe of documents (U^{ijk}), the tensor functions can be taken over the set of documents making up that universe.

5. The depiction of X₁^{ijk} and X₂^{ijk} is refined by cross-correlating them with pseudo-tensors X′₁^{ijk} and X′₂^{ijk} of equal rank to X₁^{ijk} and X₂^{ijk}, but whose elements were taken from the elements of U^{ijk}. This measure allows for tensor functions that measure the deviation of their contents from the what is otherwise expected as derived from U^{ijk}. This measurement against pseudo-union tensor allows for the construction of a digraph representation of the semantic map that is semantically richer than an undirected graph, particularly in representing semantic monotonicity.

6. The core innovation of the DSME is the coordination and differentiation of a language source along user-defined classes. As such, the efficacy of any embodiment of the DSME will depend on the quality of the user-defined classes chosen, much as the type of lens-filter applied to a telescope will dictate the usefulness of the recorded images. The principal research on which this embodiment is based was the use of part-of-speech classes. These classes have shown robust results in accurately depicting diverse semantic phenomena.

7. DSME generated semantic maps have diverse applications. Some of the more salient have been listed in the claims. There are obvious applications to document and information retrieval, as well as semantic analysis for the purposes of marketing or linguistic research. These maps also have potential applications in author identification, cryptography, automatic test-scoring, plagiarism detection, auto-summarization and a multiplicity of applications for which it is desirable to have a machine-readable semantic reference or for which the measurement and quantitative depiction of language, including graphical representations, are of use.

What is claimed is:

1. A semantic formalization method consisting of a:
a data source consisting of some body of text or otherwise machine readable language source
the differentiated formalization of that data source through distributing the representation of its content into a coordinated sets of arbitrary, user-defined, classes

2. The system of claim 1, further comprising:
the input by a user of some machine readable language source
the differentiated formalization of that user input as described in claim 1
the graphical representation of the user input as formalized into a differentiated semantic map

3. The system of claim 1, further comprising:
the input by a user of some machine readable language source
the differentiated formalization of that user input as described in claim 1
the coordination of that differentiated formalization with the differentiated formalization of other data sources

4. The system of claim 1, specifically implemented by:
defining the arbitrary classes to part-of-speech, so that nouns, verbs, etc. form unique semantic dimensions

5. The system of claim 3, further comprising:
the exploitation of coordinated differentiated formalizations in measuring the semantic content of data sources

6. The system of claim 5, further comprising:
the application of those measurements to enhance document retrieval and information extraction

7. The system of claim 5, further comprising:
the application of those measurements to the detect the semantic signatures unique to authors

8. The system of claim 5, further comprising:
the application of those measurements to encrypting and decrypting text

9. The system of claim 5, further comprising:
the application of those measurements to automatic test scoring
